(19) United States
(12) Patent Application Publication
(10) Pub. No.: US 2002/0036798 A1
(43) Pub. Date: Mar. 28, 2002

(54) Image forming apparatus incorporating no image memory with memory recall function

(76) Inventors: Hiroshi Sumiyama, Aichi-Ken (JP); Takeshi Morikawa, Itami-Shi (JP); Hironobu Nakata, Itami-Shi (JP); Munetaka Fujita, Toyokawa-Shi (JP); Tatsuji Hirakawa, Aichi-Ken (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/955,963

(22) Filed: Sep. 20, 2001

(30) Foreign Application Priority Data
Sep. 28, 2000 (JP) 2000-296220

(51) Int. Cl. B41J 1/00; B41B 1/00; B41F 1/00; G06K 1/00; G06F 15/00

(52) U.S. Cl. 358/1.15

(57) ABSTRACT

An image forming apparatus has a transfer unit for transferring image data to an image memory of a memory-incorporating apparatus via a network in response to a data transfer instruction, a reread unit for loading the image data stored in the image memory of the memory-incorporating apparatus in response to a data reread instruction, and an image output unit for outputting image data loaded by the reread unit. Thus, the image forming apparatus has the memory recall function without using an incorporated image memory.

### CROSS-REFERENCE OF RELATED APPLICATIONS

This application is based on application No. 2000-296220 filed in Japan, the entire content of which is hereby incorporated by reference.

### BACKGROUND OF THE INVENTION

The present invention relates to an image forming apparatus. More particularly, the present invention relates to an image forming apparatus which does not incorporate an image memory having the function of storing image data, or to an image forming apparatus, though the image forming apparatus incorporates an image memory having the function of storing image data, running without using the incorporated image memory. In this specification, these apparatuses are generically referred to as “image forming apparatuses incorporating no image memory.”

The present invention also relates to a system controller for controlling a system which connects a memory-incorporating apparatus incorporating an image memory to an image forming apparatus incorporating no image memory via a network.

The present invention further relates to an image forming method for outputting images by a system which connects a memory-incorporating apparatus incorporating an image memory to an image forming apparatus incorporating no image memory via a network.

There has been known an image forming apparatus incorporating an image memory in which inputted image data is stored in the image memory, and even after an image is outputted with use of the image data, the image data is still stored in the image memory, so that the image data may be loaded from the image memory for re-execution of output operation in response to a re-output instruction. This function is called a memory recall function.

However, the memory recall function has not been seen in any conventional to an image forming apparatus.

### SUMMARY OF THE INVENTION

It is an object of the present invention to provide an image forming apparatus incorporating no image memory which implements the memory recall function.

It is another object of the present invention to provide a system controller for controlling a system which connects a memory-incorporating apparatus having an incorporated image memory to an image forming apparatus incorporating no image memory via a network, which makes it possible to provide the memory recall function to the image forming apparatus incorporating no image memory.

It is still another object of the present invention to provide an image forming method for outputting images through use of a system which connects a memory-incorporating apparatus having an incorporated image memory to an image forming apparatus incorporating no image memory via a network, which makes it possible to provide the memory recall function to the image forming apparatus incorporating no image memory.

In order to accomplish the above objects, an inventor of the present invention paid attention to the point that an image forming apparatus incorporating no image memory can utilize an incorporated image memory of a memory-incorporating apparatus in the case where the image forming apparatus incorporating no image memory are connected the memory-incorporating apparatus having the incorporated image memory (ex. image forming apparatus) via a network to.

A first aspect of the present invention provides an image forming apparatus incorporating no image memory, comprising:

an input device for receiving image data as an input;

transfer means for transferring the image data received by the input device to an image memory of a memory-incorporating apparatus connected to an input device via the network;

a key for generating a signal in response to operation by a user;

reception means for receiving the image data stored in the image memory in accordance with the signal; and

a printing device for forming a image with use of the image data received by the reception means.

A second aspect of the present invention provides an image forming apparatus incorporating no image memory, comprising:

a reading device for creating image data by reading an image document;

a buffer memory for storing the image data created by the reading device;

a printing device for forming a copy of the image document on a sheet of paper based on the image data stored in the buffer memory;

transfer means for transferring the image data stored in the buffer memory to an image memory of a memory-incorporating apparatus connected to a network via the network;

a key for generating a signal in response to operation by a user;

reception means for receiving the image data stored in the image memory in accordance with the signal; and

control means for controlling the printing device which forms an image with use of the image data received by the reception means.

A third aspect of the present innovation provides an image forming method for an image forming apparatus incorporating no image memory, comprising the steps of:

receiving image data as an input;

transferring the received image data to an image memory of a memory-incorporating apparatus connected to a network via the network;

generating a signal in response to key operation by a user;

receiving the image data stored in the image memory in accordance with the signal; and

forming an image with use of the received image data.

A fourth aspect of the present innovation provides an image forming method for an image forming apparatus incorporating no image memory, comprising the steps of:

creating image data by reading an image document with a reading device;

storing the image data created with the reading device in a buffer memory;

forming a copy of the image document on a sheet of paper based on the image data stored in the buffer memory;

transferring the image data stored in the buffer memory to an image memory of a memory-incorporating apparatus connected to a network via the network;

generating a signal in response to key operation by a user;

receiving the image data stored in the image memory in accordance with the signal; and

forming an image with use of the received image data.

A fifth aspect of the present innovation provides an image forming system for connecting a memory-incorporating apparatus incorporating an image memory which can store image data to an image forming apparatus incorporating no image memory via a network, the image forming system comprising:

an input device for receiving image data as an input;

transfer means for transferring the image data received by the input device to the image memory of the memory-incorporating apparatus;

a key for generating a signal in response to operation by a user;

reception means for receiving the image data stored in the image memory of the memory-incorporating apparatus in accordance with the signal; and

a printing device for forming an image with use of the image data received by the reception means.

A sixth aspect of the present innovation provides an image forming system for connecting a memory-incorporating apparatus incorporating an image memory which can store image data to an image forming apparatus incorporating no image memory via a network, the image forming system comprising:

a reading device for creating image data by reading an image document with a reading device;

a buffer memory for storing the image data created with the reading device;

a printing device for forming a copy of the image document on a sheet of paper based on the image data stored in the buffer memory;

transfer means for transferring the image data stored in the buffer memory to the image memory of the memory-incorporating apparatus;

a key for generating a signal in response to operation by a user;

reception means for receiving the image data stored in the image memory of the memory-incorporating apparatus in accordance with the signal; and

control means for controlling the printing device which forms an image with use of the image data received by the reception means.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view showing an overall configuration of a network that connects copy machines as embodiments of the present invention to personal computers;

FIG. 2 is an exemplary cross sectional view showing an outline configuration of the copy machine;

FIG. 3 is a front view showing an operation panel of an image forming apparatus;

FIG. 4 is a block diagram showing a configuration of a control section of the copy machine;

FIG. 5 is a block diagram showing a configuration of a control section of the copy machine;

FIG. 6 is a flow chart showing a procedure for controlling a user interface and machine operation executed by a CPU;

FIG. 7 is a detailed view showing part of the flow of an image input processing relating to a memory recall function;

FIG. 8 is a detailed views showing rest of the flow of the image input processing relating to a memory recall function;

FIG. 9 is a detailed view showing the flow of an image output processing in memory recall; and

FIG. 10 is a view showing various display screens indicated on the operation panel.

### DETAILED DESCRIPTION OF THE PREFERRED EMBODIMENTS

Hereinbelow, embodiments of the present invention will be described in detail with reference to accompanied drawings.

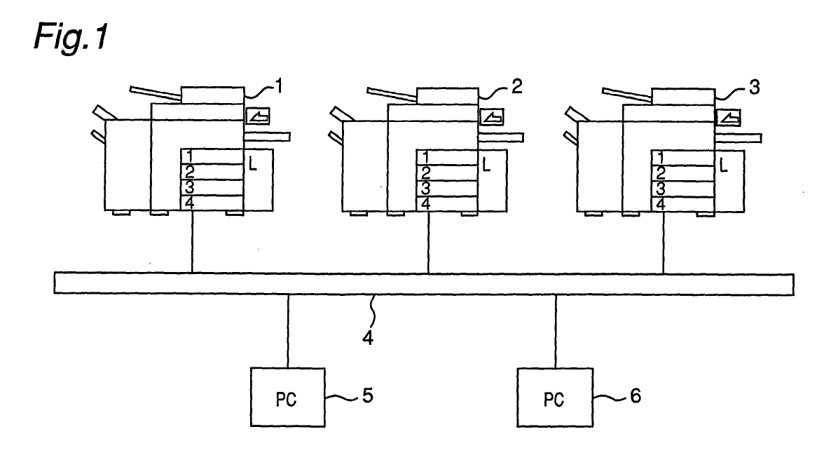

FIG. 1 shows an overall configuration of a system that connects copy machines 1, 2 and 3 serving as image forming apparatuses according to the present invention and personal computers 5 and 6 via a network 4. The copy machines 1, 2 and 3 are usable as standalone machines, while they can also be connected to the network 4 so as to enable printing of images with an instruction given by personal computers 5 and 6 and the like.

More particularly, the copy machines 1, 2 and 3, which are connected with personal computers 5 and 6 via the network 4, send image data to the copy machines 1, 2 and 3 for printing of images. In addition, each of the copy machines 1, 2 and 3 has an image reader IR, so that it is also possible to print image data that the image reader IR obtains by reading an image document.

Description will now be given of the copy machine 1. It is noted that the copy machine 1 is an image forming apparatus incorporating no image memory, and therefore has no memory for storing image data, whereas the copy machines 2 and 3 are image forming apparatuses incorporating a memory, and therefore have a memory unit section for storing image data for the memory recall function.

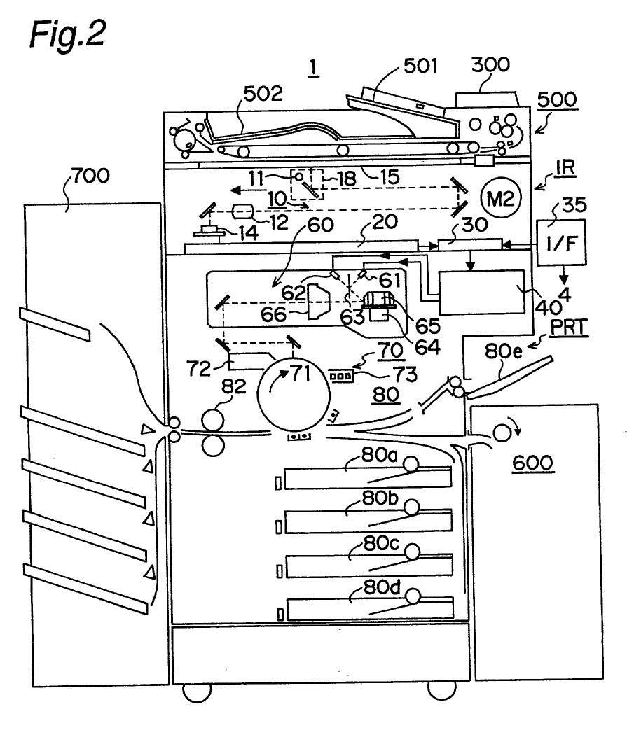

FIG. 2 is an exemplary cross sectional view showing an outline configuration of the copy machine 1.

The copy machine 1 is mainly composed of an image reader IR for reading an image document and creating image data, a buffer memory 30 for compressing/expanding image data obtained by the image reader IR, a printing device PRT for printing image data compressed/expanded by the buffer memory 30 on sheets of paper, an operation panel 300 for inputting operation, a document conveyer section 500 for conveying documents and reversing the back side and front side of the documents as necessary, a large capacity paper feeding device 600 for accommodating a large number of paper sheets and feeding them one by one, and a sorter 700 for receiving and sorting printed paper sheets. These operations are controlled by a control section described later.

In the document conveyer section 500, upon reception of a printing instruction, documents set on a document feed tray 501 are automatically set from the lowermost document sheet in a reading position on a document glass 15. Once reading by an image reader IR is finished, the documents are discharged onto a paper discharge tray 502.

The image reader IR is composed of a scanning system 10 and an image signal processing section 20.

In the scanning system 10, first, an image on a document set in the reading position is exposed by an expose lamp 11 attached to a scanner 16 moving underneath the document. Rays of light reflected from the document pass through a reflection mirror and a condenser lens 12, and come into a photoelectric transducer 14 made of CCD-arrays and the like.

Next, signals obtained in the scanning system 10 are sent to an image signal processing section 20. In the image signal processing section 20, inputted signals undergo image processing including binarization processing, image quality compensation, magnification change and image edition. Processed image data is then compressed/expanded in a buffer memory 30. The buffer memory 30 is not provided having the function of storing image data.

The printing device PRT is composed of a printing processing section 40, an optical system 60, an imaging system 70 and paper conveyer system 80.

The printing processing section 40 drives the optical system 60 in accordance with the image data transferred from the buffer memory 30. In the optical system 60, based on the signals controlled by the printing processing section 40, semiconductor lasers 61 and 62 each transmit laser beams. These laser beams are synthesized by a dichroic mirror 63, reflected by a polygon mirror 65 rotated by a motor 64, and radiated toward a photoreceptor 71 of the imaging system 70 through a main lens 66.

In the imaging system 70, first, the photoreceptor 71 is charged by an electrostatic charger 72, after which the laser beam from the optical system 60 is radiated. This forms an electrostatic latent image on the photoreceptor 71. Next, the electrostatic latent image is developed with a toner by a developing unit 73. The toner image on the photoreceptor 71 is transferred to a paper sheet fed from any of paper feed trays 80a, 80b, 80c and 80d, a large capacity paper feeding device 600, and a manual paper feed tray 80e in the paper conveyer system 80. After that, the image-transferred paper sheet is conveyed to a fuser 82, where the toner is fixed to the paper sheet by heat and pressure, and then the paper sheet is discharged to a sorter 700.

The paper feed trays 80a, 80b and 80c and the large capacity paper feeding device 600 are fixed paper feed trays, each having a regulation plate for regulating four sides of paper sheets, fixed to the position corresponding to a certain paper size, so that each tray can accommodate paper sheets of a fixed size.

The feed paper tray 80d is a universal feed paper tray having a regulation plate movable according to a paper size so as to accommodate paper sheets of various sizes.

The manual paper feed tray 80e protrudes toward outside of the copy machine, and has a regulation plate for regulating peripheral edges of paper sheets. The regulation plate is movable according to paper sheets of various fixed and unfixed sizes. Use of the manual paper feed tray 80e enables easy feed of special paper sheets other than the paper sheets set in the paper feed tray 80a, 80b, 80c and 80d, which are relatively low in usage frequency such as OHP paper sheets, thick paper sheets and color paper sheets.

The copy machine 1 includes a communication interface 35. The communication interface 35 enables transfer of image data and the like from/to external devices including the personal computers 5 and 6, and the copy machines 2 and 3 via the network 4 shown in FIG. 1 when necessary.

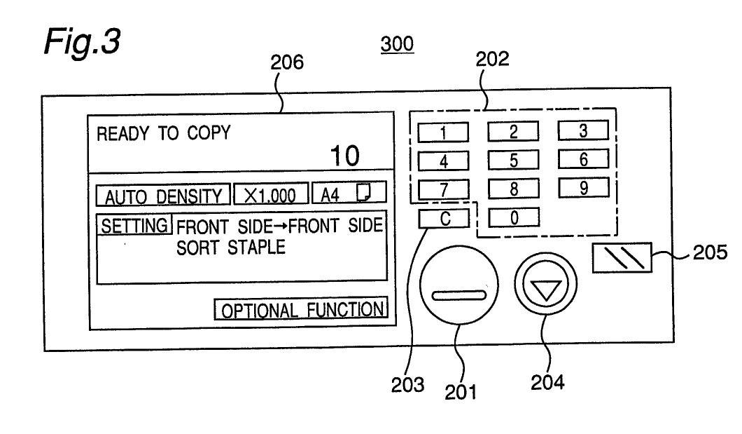

FIG. 3 is a front view showing an operation panel 300 of an image forming apparatus.

The operation panel 300 includes a start key 201 for instructing start of operation, a ten-key keypad 202 for inputting numerical values such as number of copies, a clear key 203 for clearing inputted numerical values, a stop key 204 for instructing stop of operation, a panel reset key 205 for resetting a currently set mode and for canceling print jobs, and an LCD display device 206 for displaying various modes, which has a touch panel on the surface and enables various key inputs by touching keys displayed on the LCD display device 206.

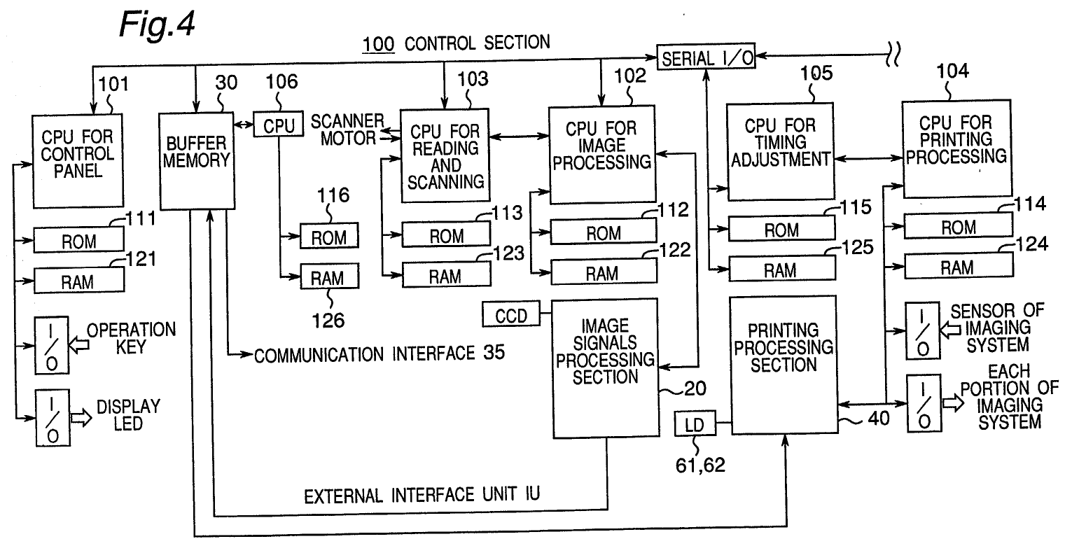

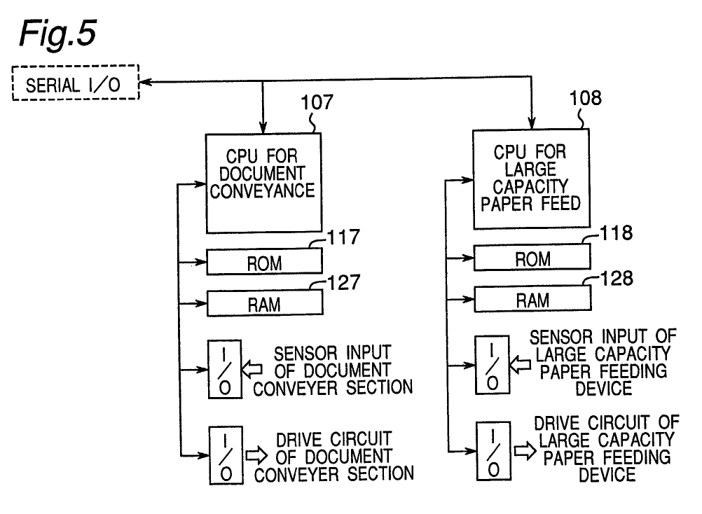

Description will now be given of a control section 100. FIGS. 4 and 5 are block diagrams showing a configuration of the control section 100 of the copy machine 1.

The control section 100 is mainly composed of eight CPUs 101 to 108. The CPUs 101 to 108 are each provided with ROMs 111 to 118 for storing programs and RAMs 121 to 128 serving as work areas for execution of the programs. The CPU 106 and the ROM 116 are included in the buffer memory 30.

The CPU 101 controls input and display of signals from various operation keys on the operation panel 300. The CPU 102 controls each portion of the image signal processing section 20, and the CPU 103 controls drive of the scanning system 10. The CPU 104 controls the printing processing section 40, the optical system 60 and the imaging system 70, while the CPU 105 conducts processing for general timing adjustment and operation mode setting of the control section 100.

The CPU 106 controls the buffer memory 30 so as to compress/expand the read image data, and transfers the compressed/expanded image data to the printing processing section 40. The CPU 106 is connected to the communication interface 35 via the network 4 as shown in FIG. 1 for sending and receiving data to/from external devices.

The CPU 107 controls the document conveyer section 500, while the CPU 108 controls the large capacity paper feeding device 600. Among the CPUs 101 to 108, serial communication with interrupt is performed for sending and receiving data.

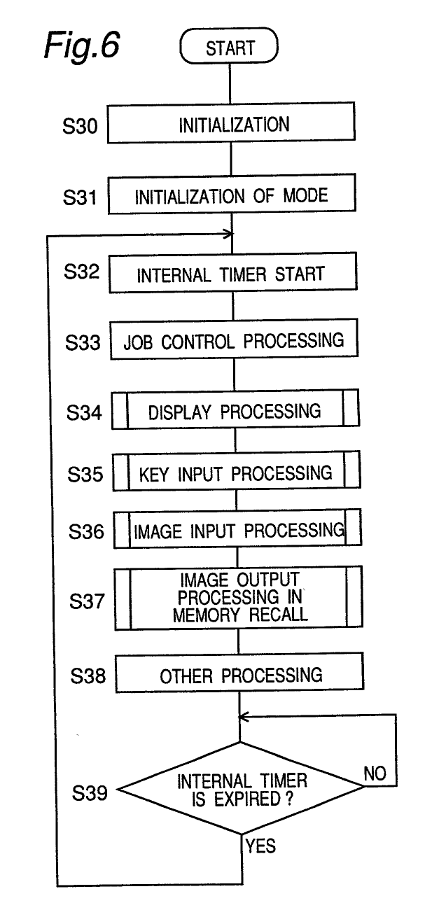

FIG. 6 is a flow chart showing a procedure for controlling a user interface and machine operation executed by the CPU 101.

Once the CPU 101 is reset and the program is started, first, there is executed initialization of the CPU 101 including clearing of a RAM and setting of various registers (Step S30), and then initialization of the mode of a copy machine is executed (Step S31).

Next, there is started an internal timer, which is incorporated in the CPU 101, and which value is set in advance in initialization (Step S32).

Then, there are executed in sequence printing job control processing for determining the state of current printing jobs (Step S33), display processing of the LCD display device 206 in the operation panel 300 (Step S34), key input processing of hard keys and a touch panel (Step S35), image input processing (Step S36), image output processing in memory recall (Step S37) and other processing (Step S38). The key input processing at the step S35 receives pressing operation of a paper feed tray select key. Detailed description will be given later of the image input processing (Step S36) and the image output processing in memory recall (Step S37).

When all the processing is ended and the initially-set internal timer is expired (Step S39), one routine is terminated and then the procedure returns to the step S32. With use of a period of time taken for this one routine, various timers involved in sub routines make a count.

In other words, various timers determine their expiration based on the number of repeated times of this one routine.

Following description discusses how the copy machine 1 implements the memory recall function with use of a memory unit of the copy machine 2, serving as a memory-incorporating apparatus connected to the network 4 (including an equivalence of the buffer memory 30 of the copy machine 1 and further including the function of storing image data). The memory recall function is implemented by the image input processing (Step S36) and the image output processing in memory recall (Step S37) shown in FIG. 6.

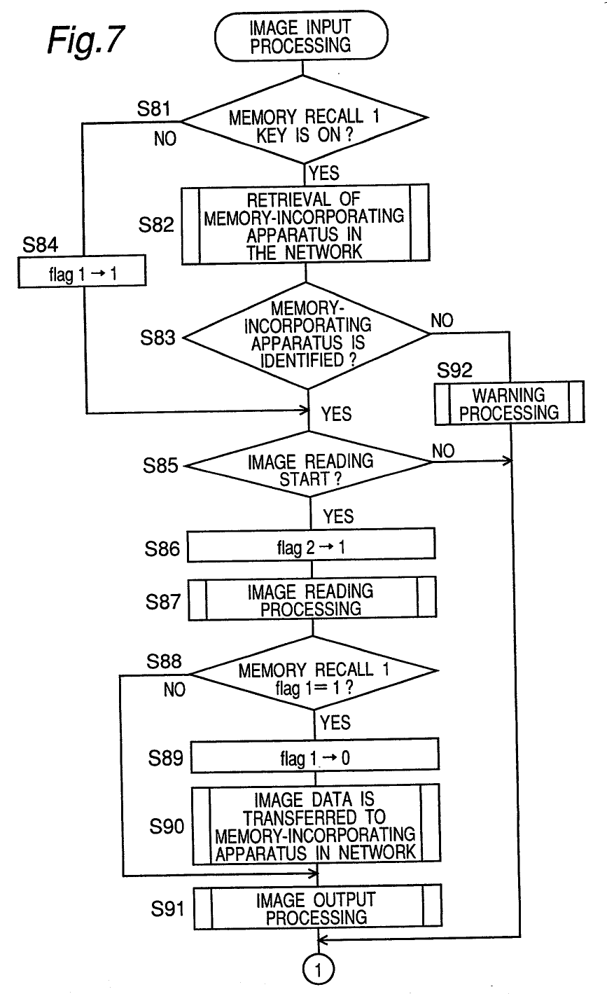

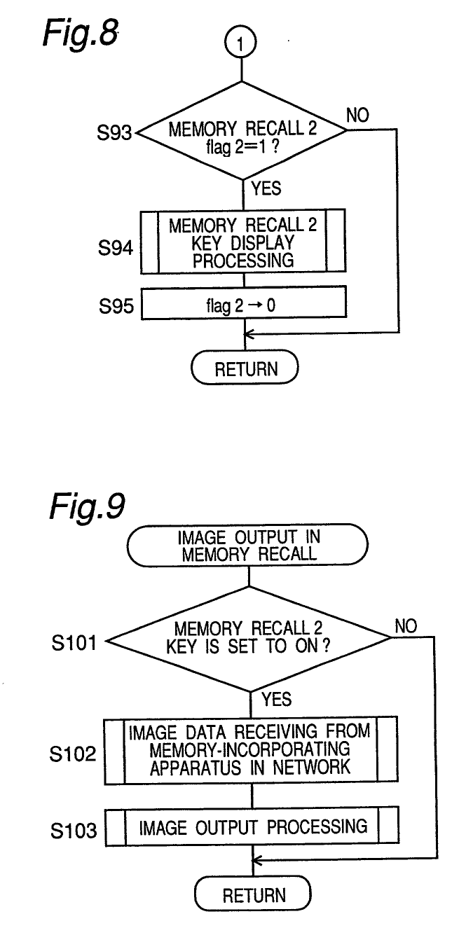

FIGS. 7 and 8 show a detailed flow of the image input processing (Step S36 in FIG. 6).

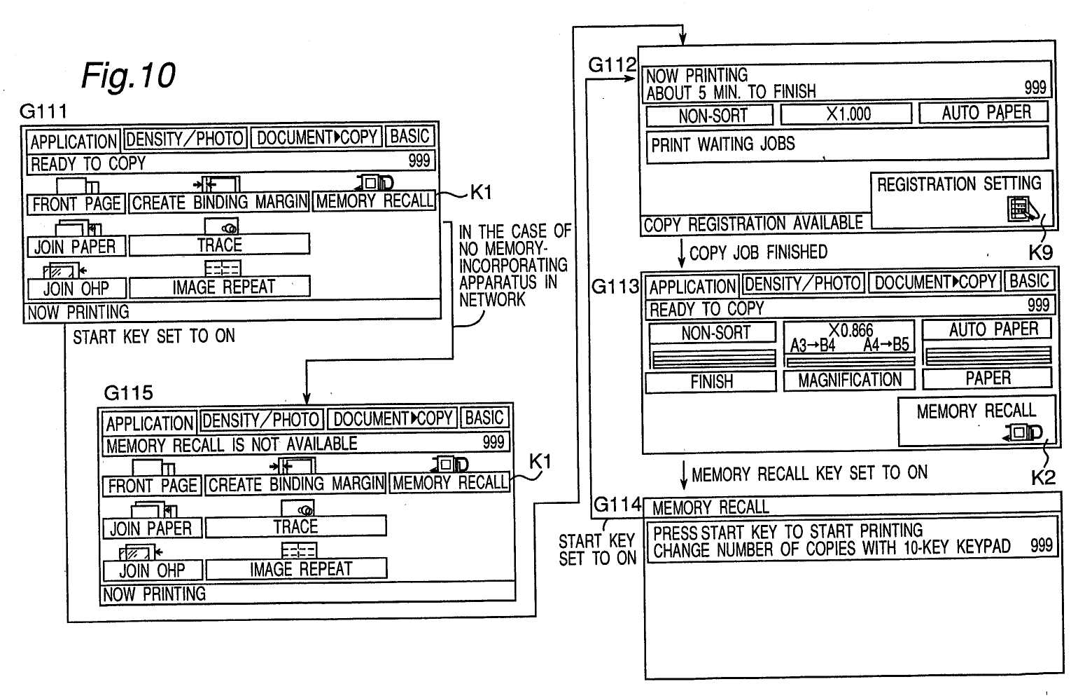

When the image input processing is started, the CPU 101 functions as a key control means to display a memory recall 1 key K1 for inputting a data transfer instruction in a display screen Gill on the operation panel as shown in FIG. 10. Users may press (ON) the memory recall 1 key K1 to input a data transfer instruction. Immediately after the memory recall 1 key K1 is displayed, the memory recall 1 key K1 is not yet pressed (“NO” at S81 in FIG. 7), and so a flag 1 for controlling the memory recall 1 key K1 (“0” in the initialized state) is set to “1” (S84). In this case, the start key 201 on the operation panel is not set to ON (“NO” at S85), and a flag 2 for controlling a memory recall 2 key mentioned later is equal to “0” (initialized state) (“NO” at S93 in FIG. 8), which makes the procedure return to the first step.

Once the memory recall 1 key K1 is set to ON (“YES” at S81 in FIG. 7), the CPU 106 functions as a retrieval means to retrieve and identify a memory-incorporating apparatus connected to the network 4, which apparatus is the copy machine 2 in this example (S82). In this flow, users do not have to identify the copy machine 2 to which image data should be transferred, resulting in providing improved convenience to users. If any memory-incorporating apparatus to which image data should be transferred is not identified, for example, because no memory-incorporating apparatus is connected to the network 4 (“NO” at S83), transfer of image data is not conducted and a message such as “memory recall is not available” is displayed in a display screen G115 on the operation panel as shown in FIG. 10 for warning users (S92 in FIG. 7). This informs users that the memory recall function is not operable. In this case, the flag 2 is also equal to “0” (“NO” at S93 in FIG. 8), which makes the procedure return to the first step.

Next, when the start key 201 on the operation panel is pressed (“YES” at S85), the flag 2 is set to “1” (S86). At the same time, the image reader IR as an image input means reads image documents and inputs resultant image data (S87).

After image reading, the CPU 106 determines whether or not the memory recall 1 key K1 was set to ON in the state that the flag 1 was equal to “1”, i.e., whether or not a data transfer instruction was received (S88). If the memory recall 1 key K1 was set to ON in the state that the flag 1 was equal to “1”, the flag 1 is set to “0” (S89). Next, the CPU 106 functions as a transfer means to transfer image data from the buffer memory 30 mounted on the CPU 106 to a memory-incorporating apparatus in the network 4, that is, to the memory unit of the copy machine 2 in this example (S90). In the case where a data transfer instruction is not received, the procedure goes to a next step S91 without executing transfer of image data to the copy machine 2.

In the next step S91, the printing device PRT performs output operation, i.e., image forming with use of the image data inputted by the image reader IR. In this point, it is preferable that a message such as “NOW PRINTING. ABOUT 5 MIN. TO FINISH” is displayed in a display screen G112 on the operation panel as shown in FIG. 10, to inform users of output operation currently under execution and of estimated time taken for the output operation. It is noted that even during printing operation, users can register new printing jobs by pressing a registration setting key K9 displayed in the display screen G112.

Next, the procedure goes to a step S93 of FIG. 8, where the CPU 101 functions as a key control means to determine whether or not the flag 2 is equal to “1”, i.e., whether or not the image reader IR executed image reading processing (S87 in FIG. 7). If the flag 2 is equal to “1”, the CPU 101 functions as a key control means to display a memory recall 2 key K2 for inputting a data reread instruction in a display screen G113 on the operation panel as shown in FIG. 10 (S94). At the same time, the flag 1 is set to “0” (S95), and the procedure returns to the first step. In this case, users may input a data reread instruction at proper timing by pressing the memory recall 2 key K2 displayed in the screen on the operation panel. In the case where the flag 2 is equal to “0” at the step S93 of FIG. 8, the procedure returns to the first step without displaying the memory recall 2 key K2.

FIG. 9 is a detailed view showing the flow of the image output processing in memory recall (step S37 in FIG. 6).

In the image output processing in memory recall, first, the CPU 101 functions as a key control means to determine whether or not the memory recall 2 key K2 (see the display screen G113 in FIG. 10) was pressed to be turned on, i.e., whether or not a data reread instruction was received (S101). If the memory recall 2 key K2 was set to ON, the CPU 106 functions as a reread means or a retransfer means to receive image data stored in the memory unit of the copy machine 2 (S102). At the same time, the CPU 101 displays a message such as “PRESS START KEY TO START PRINTING. CHANGE NUMBER OF COPIES WITH 10-KEY KEYPAD.” in a display screen G114 on the operation panel as shown in FIG. 10 to prompt users to press the start key. Once users press the start key, the printing device PRT executes output operation, i.e., image forming with use of the received image data (image data retransferred from the memory unit of the copy machine 2) (S103).

In the above configuration, presence of only one copy machine 2 incorporating a memory unit in the network 4 enables the copy machine 1 to perform output operation with use of the memory unit of the copy machine 2, resulting in implementation of the memory recall function. As a result, users can select a copy machine in the network 4 for executing output operation without considering whether the copy machine is with or without incorporating a memory unit.

In this embodiment, the copy machine 1 does not incorporate an image memory for the memory recall function. However, the copy machine 1, if incorporating an image memory (memory unit) that can store image data, is still capable of executing processing shown in FIGS. 7 to 9 in the operation mode without using the incorporated image memory.

Also in this embodiment, once the memory recall 1 key K1 is set to ON, the CPU 106 functions as a retrieval means to retrieve a memory-incorporating apparatus connected to the network 4. However, the present invention is not limited to this configuration. It is also applicable that the memory-incorporating apparatus of a transfer destination is manually set by users or the memory-incorporating apparatus of a transfer destination is preset by the copy machine 1 by default.

It is also acceptable that the memory recall 1 key K1 and the memory recall 2 key K2 are not displayed in a display screen on the operation panel 300, but provided as hard keys on the operation panel 300. Further, display of the memory recall 2 key K2 in a display screen on the operation panel 300 may be started not after but during output operation with use of the image data inputted by the image reader IR.

The memory-incorporating apparatus of a transfer destination is not limited to a copy machine, but includes image forming apparatuses such as printers and facsimiles having an image memory, personal computers and servers. The image memory may be composed of various information storage devices including hard disks.

Although, in this embodiment, the memory recall function by the copy machine 1 is implemented through control given by the control section 100 mounted on the copy machine 1, the present invention is not limited to this configuration. The memory recall function by the copy machine 1 may be implemented through, for example, control given by personal computers and servers as system controllers connected to the network 4.

As is apparent from the above description, the transfer unit transfers image data to an image memory of a memory-incorporating apparatus connected to a network in response to a data transfer instruction. The reread unit loads image data stored in the image memory of the memory-incorporating apparatus in response to a data reread instruction. The image output unit executes output of image data loaded by the reread unit, i.e., image forming. Therefore, presence of only one memory-incorporating apparatus in the network enables the image forming apparatus to perform output operation with use of the image memory of the memory-incorporating apparatus, resulting in implementation of the memory recall function. In the case where at least one memory-incorporating apparatus with an image memory incorporated (ex. image forming apparatus) and a plurality of image forming apparatuses incorporating no image memory are connected via a network, users can select an image forming apparatus for executing output operation without considering whether the apparatus is with or without incorporating an image memory.

The retrieval unit retrieves a memory-incorporating apparatus connected to the network. Once the transfer unit receives a data transfer instruction and the retrieval unit identifies the memory-incorporating apparatus to which image data should be transferred, the transfer unit transfers image data to the memory-incorporating apparatus. This saves users from identifying the memory-incorporating apparatus to which image data should be transferred, and provides improved convenience to users.

The key control unit displays at least either a first key for inputting the data transfer instruction or a second key for inputting the data reread instruction on an operation panel. A user may input the data transfer instruction by pressing the first key, and the data reread instruction by pressing the second key. This provides improved convenience to the user.

The image input unit inputs image data. The key control unit displays the second key on an operation panel during or after input operation with use of the image data inputted by the image input unit. Consequently, a user can input the data reread instruction at proper timing by pressing the second key displayed on the operation panel. This provides improved convenience to the user.

The transfer unit transfers image data from the image forming apparatus incorporating no image memory to an image memory of a memory-incorporating apparatus via a network in response to a data transfer instruction. Then, the retransfer unit retransfers image data stored in the image memory of the memory-incorporating apparatus to the image forming apparatus incorporating no image memory via a network in response to a data reread instruction. Therefore, presence of only one memory-incorporating apparatus in the network enables the image forming apparatus incorporating no image memory to perform output operation with use of the image memory of the memory-incorporating apparatus, resulting in implementation of the memory recall function. In the case where at least one memory-incorporating apparatus with an image memory incorporated (ex. image forming apparatus) and a plurality of image forming apparatuses incorporating no image memory are connected via a network, users can select an image forming apparatus for executing output operation without considering whether the apparatus is with or without incorporating an image memory.

First, image data is transferred from a image forming apparatus incorporating no image memory to an image memory of a memory-incorporating apparatus via a network (transfer step). Next, the image data stored in the image memory of the memory-incorporating apparatus is retransferred to the image forming apparatus incorporating no image memory via a network in response to a data reread instruction (retransfer step). With use of the retransferred image data, output operation is executed by the image forming apparatus incorporating no image memory (image output step). Therefore, presence of only one memory-incorporating apparatus in the network enables the image forming apparatus incorporating no image memory to perform output operation with use of the image memory of the memory-incorporating apparatus , resulting in implementation of the memory recall function. In the case where at least one memory-incorporating apparatus with an image memory incorporated (ex. image forming apparatus) and a plurality of image forming apparatuses incorporating no image memory are connected via a network, users can select an image forming apparatus for executing output operation without considering whether the apparatus is with or without incorporating an image memory.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

What is claimed is:

1. An image forming apparatus incorporating no image memory, comprising:
an input device for receiving image data as an input;
transfer means for transferring the image data received by the input device to an image memory of a memory-incorporating apparatus connected to an input device via the network;
a key for generating a signal in response to operation by a user;
reception means for receiving the image data stored in the image memory in accordance with the signal; and
a printing device for forming a image with use of the image data received by the reception means.

2. The image forming apparatus as defined in claim 1, further comprising:
retrieval means for retrieving the memory-incorporating apparatus connected to the network.

3. The image forming apparatus as defined in claim 2, wherein
the transfer means transfers the image data to the memory-incorporating apparatus retrieved by the retrieval means.

4. The image forming apparatus as defined in claim 2, further comprising:
a warning device for informing a user that the retrieval means can not identify any memory-incorporating apparatus.

5. The image forming apparatus as defined in claim 2, further comprising:
transfer instruction means for inputting a data transfer instruction in response to operation by a user, wherein
the retrieval means retrieves the memory-incorporating apparatus when the data transfer instruction is inputted.

6. The image forming apparatus as defined in claim 1, wherein the key is displayed on a display device.

7. The image forming apparatus as defined in claim 6, wherein
the key is displayed when the retrieval means identifies a memory-incorporating apparatus, whereas the key is not displayed when the retrieval means identifies no memory-incorporating apparatus.

8. The image forming apparatus as defined in claim 6, wherein the key is displayed on the display device during or after image forming operation by the printing device with use of image data inputted by the input device.

9. An image forming apparatus incorporating no image memory, comprising:
a reading device for creating image data by reading an image document;
a buffer memory for storing the image data created by the reading device;
a printing device for forming a copy of the image document on a sheet of paper based on the image data stored in the buffer memory;
transfer means for transferring the image data stored in the buffer memory to an image memory of a memory-incorporating apparatus connected to a network via the network;
a key for generating a signal in response to operation by a user;
reception means for receiving the image data stored in the image memory in accordance with the signal; and
control means for controlling the printing device which forms an image with use of the image data received by the reception means.

10. The image forming apparatus as defined in claim 9, further comprising:
retrieval means for retrieving the memory-incorporating apparatus connected to the network.

11. The image forming apparatus as defined in claim 10, wherein
the transfer means transfers the image data to the memory-incorporating apparatus retrieved by the retrieval means.

12. The image forming apparatus as defined in claim 10, further comprising:
a warning device for informing a user that the retrieval means can not identify any memory-incorporating apparatus.

13. The image forming apparatus as defined in claim 10, further comprising:
transfer instruction means for inputting a data transfer instruction in response to operation by a user, wherein
the retrieval means retrieves the memory-incorporating apparatus when the data transfer instruction is inputted.

14. The image forming apparatus as defined in claim 9, wherein
the key is displayed on a display device.

15. The image forming apparatus as defined in claim 14, wherein
the key is displayed when the retrieval means identifies a memory-incorporating apparatus, whereas the key is not displayed when the retrieval means identifies no memory-incorporating apparatus.

16. The image forming apparatus as defined in claim 14, wherein
the key is displayed on a display device during or after image forming operation by the printing device with use of image data inputted by the input device.

17. An image forming method for an image forming apparatus incorporating no image memory, comprising the steps of:
receiving image data as an input;
transferring the received image data to an image memory of a memory-incorporating apparatus connected to a network via the network;
generating a signal in response to key operation by a user;
receiving the image data stored in the image memory in accordance with the signal; and
forming an image with use of the received image data.

18. An image forming method for an image forming apparatus incorporating no image memory, comprising the steps of:
creating image data by reading an image document with a reading device;
storing the image data created with the reading device in a buffer memory;
forming a copy of the image document on a sheet of paper based on the image data stored in the buffer memory;
transferring the image data stored in the buffer memory to an image memory of a memory-incorporating apparatus connected to a network via the network;
generating a signal in response to key operation by a user;
receiving the image data stored in the image memory in accordance with the signal; and
forming an image with use of the received image data.

19. An image forming system for connecting a memory-incorporating apparatus incorporating an image memory which can store image data to an image forming apparatus incorporating no image memory via a network, the image forming system comprising:
an input device for receiving image data as an input;
transfer means for transferring the image data received by the input device to the image memory of the memory-incorporating apparatus;
a key for generating a signal in response to operation by a user;
reception means for receiving the image data stored in the image memory of the memory-incorporating apparatus in accordance with the signal; and
a printing device for forming an image with use of the image data received by the reception means.

20. An image forming system for connecting a memory-incorporating apparatus incorporating an image memory which can store image data to an image forming apparatus incorporating no image memory via a network, the image forming system comprising:
a reading device for creating image data by reading an image document with a reading device;
a buffer memory for storing the image data created with the reading device;
a printing device for forming a copy of the image document on a sheet of paper based on the image data stored in the buffer memory;
transfer means for transferring the image data stored in the buffer memory to the image memory of the memory-incorporating apparatus;
a key for generating a signal in response to operation by a user;
reception means for receiving the image data stored in the image memory of the memory-incorporating apparatus in accordance with the signal; and
control means for controlling the printing device which forms an image with use of the image data received by the reception means.
